(19) United States
(12) Patent Application Publication
(10) Pub. No.: US 2018/0102675 A1
(43) Pub. Date: Apr. 12, 2018

(54) HYBRID RECTIFICATION FOR WIRELESS POWER

(71) Applicant: QUALCOMM Incorporated, San Diego, CA (US)

(72) Inventors: Cody Burton WHEELAND, San Diego, CA (US); William Henry VON NOVAK, III, San Diego, CA (US); Joseph MAALOUF, San Diego, CA (US); Mark WHITE, II, Solana Beach, CA (US)

(21) Appl. No.: 15/290,294

(22) Filed: Oct. 11, 2016

(51) Int. Cl. H02J 50/12; H02J 7/02; H02J 50/80

(52) U.S. Cl. CPC H02J 50/12; H02J 50/80; H02J 7/025

(57) ABSTRACT

Certain aspects of the present disclosure relate to methods and apparatus for hybrid rectification for wireless power. Certain aspects of the present disclosure provide a wireless power receiver. The wireless power receiver includes a resonator configured to couple to a wireless field. The wireless field induces a voltage in the resonator. The wireless power receiver further includes an active rectifier comprising one or more switches. The wireless power receiver further includes a passive rectifier comprising one or more diodes. The wireless power receiver further includes a switch selectively coupling the active rectifier and the passive rectifier to the resonator.

### TECHNICAL FIELD

The present disclosure relates generally to wireless power transfer, and in particular to hybrid rectification for wireless power.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, medical implants, and the like. While battery technology has improved, battery-powered electronic devices increasingly require and consume greater amounts of power. As such, these devices constantly require recharging. Rechargeable devices are often charged via wired connections that require cables or other similar connectors that are physically connected to a power supply. Cables and similar connectors may sometimes be inconvenient or cumbersome and have other drawbacks. Wireless power transfer systems, for example, may allow users to charge and/or power electronic devices without physical, electrical connections, thus reducing the number of components required for operation of the electronic devices and simplifying the use of the electronic device.

For example, some battery powered devices, such as medical implants (e.g., pacemakers, neuromodulation devices, insulin pumps, etc.) may be located/positioned in areas where replacing the battery is not always feasible (e.g., in a body, such as, a human body). For example, to change a battery for a medical implant, surgery may need to be performed, which is risky. Accordingly, it may be safer to charge such devices wirelessly.

Further, some electronic devices may not be battery powered, but it still may be beneficial to utilize wireless power transfer to power such devices. In particular, the use of wireless power may eliminate the need for cords/cables to be attached to the electronic devices, which may be inconvenient and aesthetically displeasing.

Different electronic devices may have different shapes, sizes, and power requirements. There is flexibility in having different sizes and shapes in the components (e.g., magnetic coil, charging plate, etc.) that make up a wireless power transmitter and/or a wireless power receiver in terms of industrial design and support for a wide range of devices

### SUMMARY

Certain aspects of the present disclosure provide a wireless power receiver. The wireless power receiver includes a resonator configured to couple to a wireless field. The wireless field induces a voltage in the resonator. The wireless power receiver further includes an active rectifier comprising one or more switches. The wireless power receiver further includes a passive rectifier comprising one or more diodes. The wireless power receiver further includes a switch selectively coupling the active rectifier and the passive rectifier to the resonator.

Certain aspects of the present disclosure provide a method for operating a wireless power receiver. The method includes determining an operating parameter of the wireless power receiver. The method further includes selectively coupling an active rectifier and a passive rectifier to a resonator of the wireless power receiver based on the determined parameter.

Certain aspects of the present disclosure provide a wireless power receiver. The wireless power receiver includes a resonator configured to couple to a wireless field. The wireless field induces a voltage in the resonator. The wireless power receiver further includes a passive rectifier comprising one or more diodes. The wireless power receiver further includes a switch configured to selectively couple a shunt tuning capacitor or a series tuning capacitor to the passive rectifier.

Certain aspects of the present disclosure provide a wireless power receiver. The wireless power receiver includes means for coupling the wireless power receiver to a wireless field. The wireless field induces a voltage in the coupling means. The wireless power receiver further includes means for actively rectifying the induced voltage in the coupling means. The wireless power receiver further includes means for passively rectifying the induced voltage in the coupling means. The wireless power receiver further includes means for selectively operating the actively rectifying means and the passively rectifying means based on the induced voltage in the coupling means.

The following detailed description and accompanying drawings provide a better understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. In the accompanying drawings:

FIG. 1 is a functional block diagram of a wireless power transfer system in accordance with an illustrative aspect.

FIG. 2 is a functional block diagram of a wireless power transfer system in accordance with an illustrative aspect.

FIG. 3 is a schematic diagram of a portion of transmit circuitry or receive circuitry of FIG. 2 including a power transmitting or receiving element in accordance with an illustrative aspect.

FIG. 4 is a graph illustrating the difference in voltage gain between an example shunt tuned receiver and an example series tuned receiver in accordance with an illustrative aspect.

FIG. 5 is a graph illustrating the difference in input power dissipated in a resonator of a wireless power receiver between an example shunt tuned receiver and an example series tuned receiver in accordance with an illustrative aspect.

FIG. 6 is a circuit diagram illustrating an example wireless power receiver including a hybrid rectifier, according to aspects of the disclosure.

FIG. 6A is a circuit diagram illustrating another example of the wireless power receiver including a hybrid rectifier, according to aspects of the disclosure.

FIG. 7 is a circuit diagram illustrating another example of the wireless power receiver including a hybrid rectifier, according to aspects of the disclosure.

FIG. 7A is a circuit diagram illustrating another example of the wireless power receiver including a hybrid rectifier, according to aspects of the disclosure.

FIG. 8 is a circuit diagram illustrating another example of the wireless power receiver including a hybrid rectifier, according to aspects of the disclosure.

FIG. 9 is a circuit diagram illustrating another example of the wireless power receiver including a hybrid rectifier, according to aspects of the disclosure.

FIG. 10 is a flowchart of example operations for wireless power rectification, in accordance with certain aspects of the present disclosure.

### DETAILED DESCRIPTION

Drawing elements that are common among the following figures may be identified using the same reference numerals.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “power receiving element” to achieve power transfer.

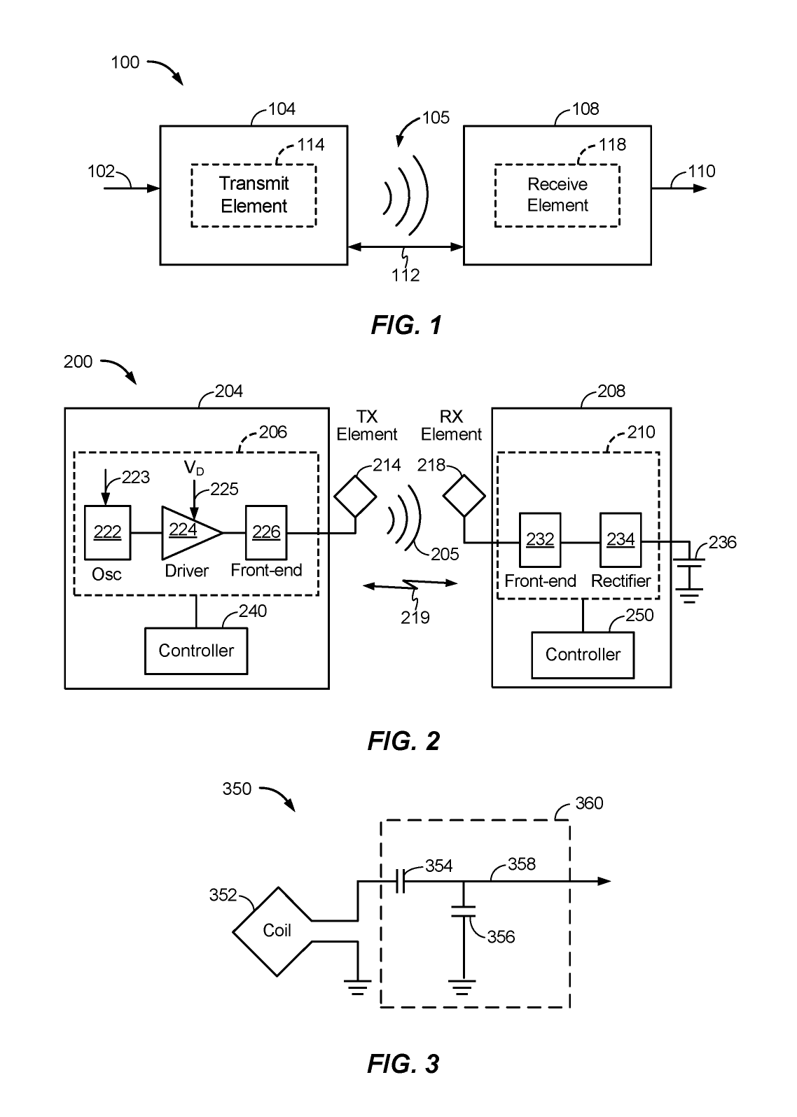

FIG. 1 is a functional block diagram of a wireless power transfer system 100, in accordance with an illustrative aspect. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) coupled to the output power 110. The transmitter 104 and the receiver 108 may be separated by a distance 112. The transmitter 104 may include a power transmitting element 114 for transmitting/coupling energy to the receiver 108. The receiver 108 may include a power receiving element 118 for receiving or capturing/coupling energy transmitted from the transmitter 104.

In one illustrative aspect, the transmitter 104 and the receiver 108 may be configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over larger distances. Resonant inductive coupling techniques may thus allow for improved efficiency and power transfer over various distances and with a variety of inductive power transmitting and receiving element configurations.

In certain aspects, the wireless field 105 may correspond to the “near field” of the transmitter 104. The near-field may correspond to a region in which there are strong reactive fields resulting from the currents and charges in the power transmitting element 114 that minimally radiate power away from the power transmitting element 114. The near-field may correspond to a region that is within about one wavelength (or a fraction thereof) of the power transmitting element 114. Conversely, the far field may correspond to a region that is greater than about one wavelength of the power transmitting element 114.

In certain aspects, efficient energy transfer may occur by coupling a large portion of the energy in the wireless field 105 to the power receiving element 118 rather than propagating most of the energy in an electromagnetic wave to the far field.

In certain implementations, the transmitter 104 may output a time varying magnetic (or electromagnetic) field with a frequency corresponding to the resonant frequency of the power transmitting element 114. When the receiver 108 is within the wireless field 105, the time varying magnetic (or electromagnetic) field may induce a current in the power receiving element 118. As described above, if the power receiving element 118 is configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge or to power a load.

FIG. 2 is a functional block diagram of a wireless power transfer system 200, in accordance with another illustrative aspect. The system 200 may include a transmitter 204 and a receiver 208. The transmitter 204 (also referred to herein as power transfer unit, PTU) may include transmit circuitry 206 that may include an oscillator 222, a driver circuit 224, and a front-end circuit 226. The oscillator 222 may be configured to generate an oscillator signal (e.g., an oscillating signal) at a desired frequency (e.g., fundamental frequency) that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output as a driving signal output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or otherwise powering a load.

The transmitter 204 may further include a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by it. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) may include receive circuitry 210 that may include a front-end circuit 232 and a rectifier circuit 234. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 2. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. In certain aspects, the transmitter 204 may be configured to generate a predominantly non-radiative field with a direct field coupling coefficient (k) for providing energy transfer. Receiver 208 may directly couple to the wireless field 205 and may generate an output power for storing or consumption by a battery (or load) 236 coupled to the output or receive circuitry 210.

The receiver 208 may further include a controller 250 configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to minimize transmission losses between the transmitter 204 and the receiver 208.

FIG. 3 is a schematic diagram of a portion of the transmit circuitry 206 or the receive circuitry 210 of FIG. 2, in accordance with illustrative aspects. As illustrated in FIG. 3, transmit or receive circuitry 350 may include a power transmitting or receiving element 352 and a tuning circuit 360. The power transmitting or receiving element 352 may also be referred to or be configured as an antenna or a “loop” antenna. The term “antenna” generally refers to a component that may wirelessly output or receive energy for coupling to another antenna. The power transmitting or receiving element 352 may also be referred to herein or be configured as a “magnetic” antenna, or an induction coil, a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown in this figure). In some aspects, the term resonator, as used herein may refer to the entire resonant circuit including an inductor in combination with the capacitance of one or more capacitors of the resonant circuit.

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non limiting example, the tuning circuit 360 may comprise a capacitor 354 and a capacitor 356, which may be added to the transmit and/or receive circuitry 350 to create a resonant circuit.

The tuning circuit 360 may include other components to form a resonant circuit with the power transmitting or receiving element 352. As another non limiting example, the tuning circuit 360 may include a capacitor (not shown) placed in parallel between the two terminals of the circuitry 350. Still other designs are possible. In some aspects, the tuning circuit in the front-end circuit 226 may have the same design (e.g., 360) as the tuning circuit in front-end circuit 232. In other aspects, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

In certain aspects, the induced voltage at a wireless power receiving device (e.g., medical implant) with a wireless power receiver (e.g., receiver 208) due to a wireless field (e.g., wireless field 205 generated by a wireless power transmitter (e.g., transmitter 204) may be low (e.g., ˜50 mV)). For example, the coupling between the wireless power receiver 208 and the wireless power transmitter 204 may be low due to distance or material between the receiver 208 and the transmitter 204, leading to a low induced voltage at the receiver 208. For example, where the wireless power receiving device is an implant, body tissue between the receiver 208 and the transmitter 204 may cause low coupling between the receiver 208 and transmitter 204. In other aspects, the induced voltage at the receiver 208 may be low for a number of other reasons.

When the induced voltage at the receiver 208 is low, the receiver 208 may not have enough voltage to forward bias a diode (e.g., a diode of a rectifier for providing DC power to the load). For example, a diode may start conducting current when approximately 500 mV is applied to the diode. If the induced voltage at the receiver 208 is low (e.g., ˜50 mV), the receiver 208 may not have sufficient voltage to forward bias the diode. In certain aspects, a rectifier 234 of the receiver 208 may comprise a passive rectifier which includes one or more diodes. Accordingly, the receiver 208 may not have sufficient voltage to operate the rectifier 234, and therefore, is not able to generate a DC power output from an AC power input to charge a battery (e.g., battery 236) or power a load (e.g., power management integrated circuit (PMIC)) of a device (e.g., medical implant) that includes the receiver 208.

In certain aspects, the rectifier 234 of the receiver 208, instead of being a passive rectifier, may be an active rectifier. In particular, an active rectifier may include one or more switches (e.g., transistors, such as, field-effect transistors (FETs)). Such transistors may be able to conduct current even at low voltages (e.g., ˜50 mV) induced at the receiver 208. However, to control the operation of the transistors, a sufficient bias voltage (e.g., between a gate terminal and a source terminal of the transistor) of ˜500 mV or higher may need to be applied. Accordingly, again, the receiver 208 may not have sufficient voltage to operate the rectifier 234, and therefore, is not able to generate a DC power output from an AC power input to charge a battery (e.g., battery 236) or power a load of a device (e.g., medical implant) that includes the receiver 208. In certain aspects, if the receiver 208 is coupled to a battery (e.g., battery 236) and the battery has sufficient charge to produce a sufficient voltage, the battery can be used to operate the transistors. However, in certain circumstances, the battery of a device may not have sufficient charge. Accordingly, certain aspects discussed herein relate to systems and methods for hybrid rectification for wireless power. In particular, certain aspects of the present disclosure are directed to systems and methods for a hybrid rectifier that utilizes a passive rectifier and an active rectifier in a single receiver 208. Further, certain aspects of the present disclosure are directed to systems and methods for a hybrid rectifier where the receiver 208 is selectively series tuned or shunt tuned, such as, by selectively coupling and decoupling a series tuning capacitor or a shunt tuning capacitor to a resonator of the receiver 208. In such aspects, the receiver 208 may be able to operate even with low coupling to a transmitter 204 and even if there is no battery coupled to the receiver 208, or the battery is dead.

In certain aspects, the rectifier 234 of the receiver 208 may include a highly tuned passive rectifier. A passive rectifier may utilize only passive components (e.g., diodes and not switches) to operate and therefore not require additional energy to control the components of the passive rectifier beyond the diodes themselves that act as the passive rectifier. The highly tuned passive rectifier may be configured to have a high voltage gain and therefore significantly increase the output voltage given a low input voltage. Accordingly, a low induced voltage at the receiver 208 may be converted to a higher voltage sufficient to operate a load of the receiver 208. For example, the passive rectifier of the rectifier 234 may include a shunt tuned circuit tuned to an operating frequency (e.g., the resonant frequency of the magnetic field) of a resonator 352 of the receiver 208.

However, the voltage gain of such a highly tuned passive rectifier may also vary based on the coupling between the transmitter 204 and receiver 208, and as the load powered by the receiver 208 changes, modeled as a current source. If the voltage gain gets too high, there can be significant voltage stress on the circuitry (e.g., receive circuitry 210) of the receiver 208. Further, as the load increases, there can be significant input power dissipated on the resonator 352 of the receiver 208.

Accordingly, in certain aspects, the rectifier 234 may also include an active rectifier (e.g., including one or more active elements such as switches), such as a series tuned rectifier, in addition to the passive rectifier. The active rectifier may not function at low voltage levels as discussed. However, once the voltage levels are sufficient, the series tuned rectifier may have lower power dissipation on the resonator 352 of the receiver 208, a controlled gain to reduce voltage stress on the circuitry (e.g., receive circuitry 210) of the receiver 208, and act like a voltage source, regardless of the coupling between the transmitter 204 and receiver 208.

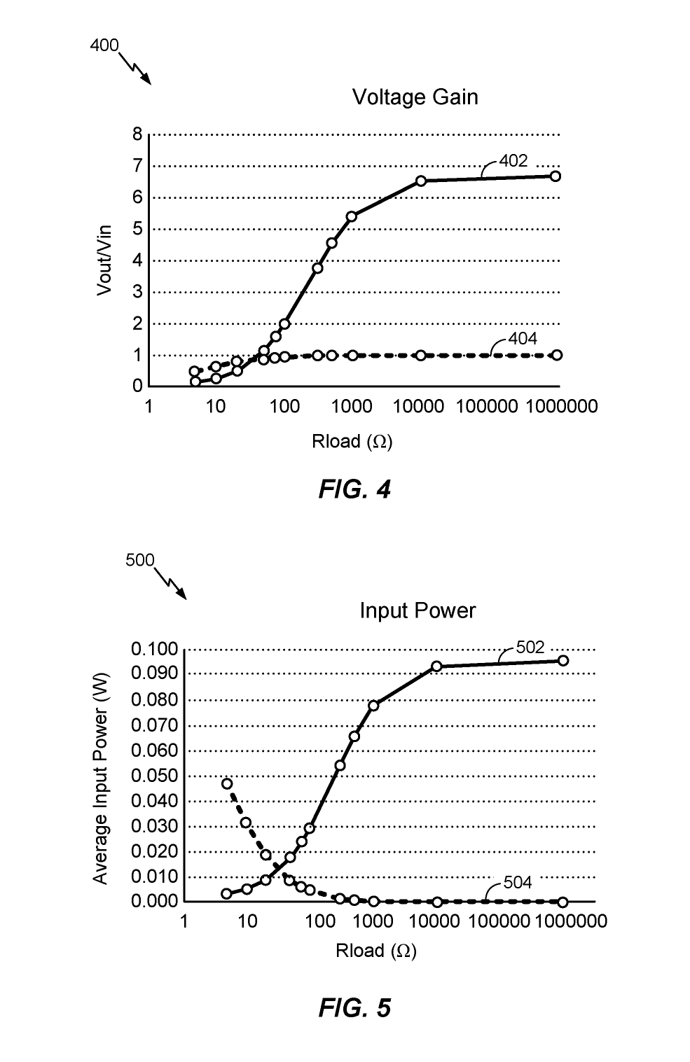

FIG. 4 is a graph 400 illustrating the difference in voltage gain between an example shunt tuned wireless power receiver and an example series tuned wireless power receiver. As shown, the Y-axis represents the voltage gain (V_{OUT}/V_{IN}) of each receiver, and the X-axis represents the resistance (Ω) of the load coupled to and supplied by each receiver. Line 402 represents the voltage gain of the shunt tuned receiver, and line 404 represents the voltage gain of the series tuned receiver. As shown, the voltage gain of the shunt tuned receiver is highly dependent on the resistance of the load, but can advantageously be greater than that of the series tuned receiver when the input voltage (V_{IN}) is low, and supply a higher output voltage (V_{OUT}). Unlike the shunt tuned receiver, the voltage gain of the series tuned receiver can be maintained at about 1, regardless of the resistance of the load. Accordingly, as discussed, the shunt tuned receiver may be used when there is not sufficient voltage at the receiver 208 to operate the active portions of the receiver (e.g., active rectifier), however, the series tuned receiver may be used once there is sufficient voltage to prevent the voltage gain from getting too high. Further, it should be noted that the shunt tuned receiver has a relatively flat and high gain at high resistance for the load (e.g., when the shunt tuned receiver is unloaded or little power is drawn from the shunt tuned receiver). Accordingly, the shunt tuned receiver can be used to power (e.g., kickstart) active portions of the receiver with a relatively high gain, even at low induced voltages, before power is drawn by a load (e.g., reducing the resistance for the load), since the active circuitry itself may draw little power.

FIG. 5 is a graph 500 illustrating the difference in input power dissipated in a resonator of a wireless power receiver between an example shunt tuned wireless power receiver and an example series tuned wireless power receiver. As shown, the Y-axis represents the input power (W) dissipated in a resonator (e.g., resonator 352 of receiver 208) of each receiver, and the X-axis represents the resistance (Ω) of the load coupled to and supplied by each receiver. Line 502 represents the input power dissipated of the shunt tuned receiver, and line 504 represents the input power dissipated of the series tuned receiver. As shown, based on the load conditions, even at low loads the input power dissipated in the resonator of the shunt tuned receiver can be much higher than the input power dissipated in the resonator of the series tuned receiver. Accordingly, as discussed, the shunt tuned receiver may be used when there is not sufficient voltage at the receiver 208 to operate an active rectifier, however, the series tuned receiver may be used once there is sufficient voltage to prevent the input power dissipated on the resonator from being too high.

In certain aspects, the receiver 208, in addition to including a rectifier 234 for both a series tuned and a shunt tuned receiver, includes control circuitry for controlling whether the passive rectifier or the active rectifier is used for rectification in the receiver 208, and/or whether a shunt tuning capacitor or series tuning capacitor is coupled to the receiver 208. For example, the control circuitry may comprise one or more switches (e.g., transistors) that selectively couple either the passive rectifier or the active rectifier, and/or the shunt tuning capacitor or series tuning capacitor to the resonator 352 of the receiver 208. For example, at low voltage levels induced at the receiver 204 (e.g., based on wireless power being received from the transmitter 208) or a low power level, such as a low or dead battery, the control circuitry may couple the passive rectifier to the resonator 352 of the receiver 208, and/or a shunt tuning capacitor. Once voltage levels or power levels are sufficient to control the active rectifier (e.g., switches of the active rectifier), the control circuitry may couple the active rectifier to the resonator 352 of the receiver 208, instead of or in addition to the passive rectifier. The control circuitry may also disconnect the shunt tuning capacitor. The control circuitry may also couple a series tuning capacitor. In some aspects, the control circuitry may include the controller 250, and one or more switches coupled to the controller 250. The controller 250 may selectively open and close the one or more switches of the control circuitry by supplying control signals to the switches. The controller 250 may comprise an integrated circuit, power management integrated circuit (PMIC), processor, etc.

It should be noted that though the passive rectifier and active rectifier may be shown or described with particular circuit layouts, other appropriate circuit layouts may be used according to the techniques described herein. Further, it should be noted that the operation of the hybrid rectifiers described herein in either a passive rectification mode, active rectification mode, or both, and/or connection of shunt or series tuning capacitors, may be based on one or more of the battery status (dead battery) of the wireless power receiver that includes the hybrid rectifier, a rectified voltage at the wireless power receiver, an induced voltage at the wireless power receiver, and a load power of the wireless power receiver. The control may be based on the topology of the rectification.

In one example, if a charge level of the battery is good, only the active rectifier, or both the active rectifier and the passive rectifier may be used for example with a series tuned receiver. If the charge level of the battery is bad, or dead, only the passive rectifier may be used for example with a shunt tuned receiver. In another example, once the passive rectifier rectifies and boosts the induced voltage to a sufficient level (e.g., ˜5V) to operate the active rectifier, the active rectifier begins drawing power and operating, regardless of the state of the battery. The passive rectifier may continue operating until the active rectifier is able to maintain the sufficient level of output voltage on its own, and then may be decoupled from the wireless power receiver.

In another example, if a wireless power receiver is able to communicate with the wireless power transmitter (e.g., via inband or out of band signaling), the wireless power receiver may indicate to the wireless power transmitter to increase the induced voltage at the wireless power receiver when the passive rectifier is decoupled from the wireless power receiver or when the shunt tuning capacitor is decoupled from the wireless power receiver. For example, the wireless power transmitter may increase its wireless field output to a specific level for a specific amount of time (e.g., using an open loop scheme) to allow the wireless power receiver to transition from passive rectification to active rectification, and then switch out the passive rectifier or decouple the shunt tuning capacitor. Once the passive rectifier is switched out or shunt tuning capacitor is decoupled, the wireless power receiver may indicate to the wireless power transmitter to further increase the induced voltage at the wireless power receiver. Similarly, the wireless power transmitter may increase its wireless field output to a specific level for a specific amount of time (e.g., using an open loop scheme) to allow the wireless power receiver to transition from shunt tuning to series tuning, and then switch out the shunt tuning capacitor.

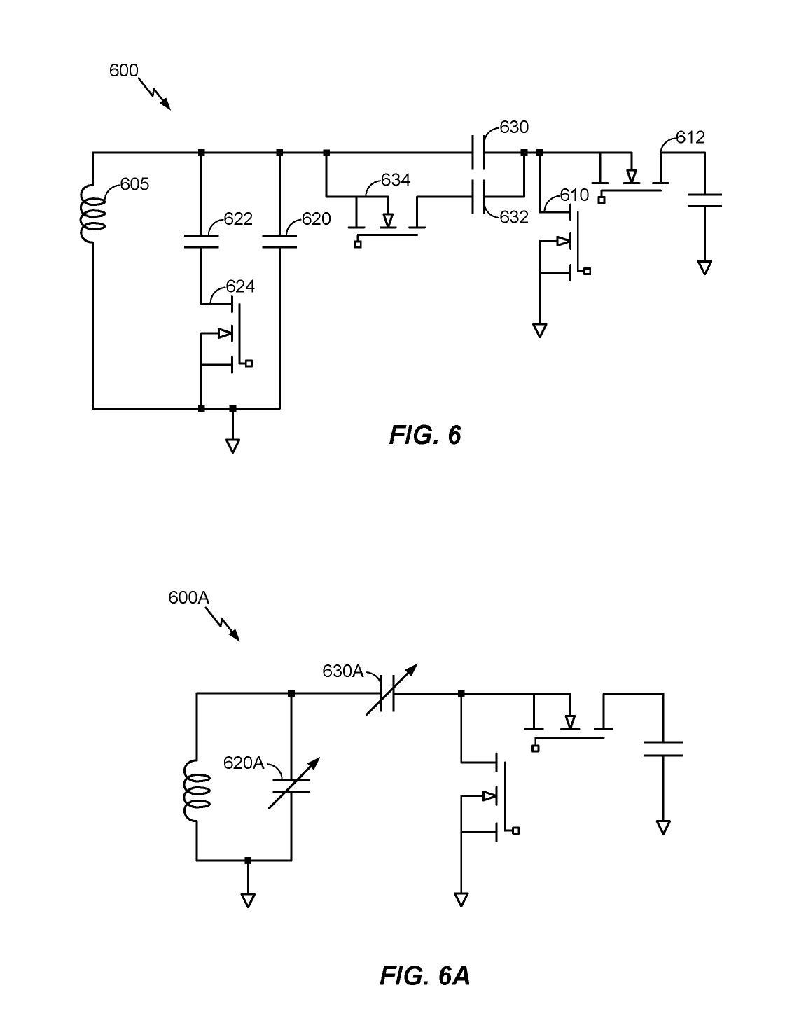

FIG. 6 is a circuit diagram illustrating an example wireless power receiver 600 including a hybrid rectifier, according to aspects of the disclosure. The wireless power receiver 600 includes a resonator 605. The wireless power receiver 600 further includes a first transistor 610 and a second transistor 612. The first transistor 610 and the second transistor 612 may function as a hybrid rectifier for the wireless power receiver 600. In particular, the first transistor 610 and the second transistor 612 may function as both a passive rectifier and an active rectifier. For example, the first transistor 610 and second transistor 612 may be FETs, where the body of the FET operates as a body diode. Accordingly, the body diodes of the first transistor 610 and second transistor 612 may function as a passive rectifier and be coupled in the circuit of the wireless power receiver at the position of the first transistor 610 and second transistor 612. Though not shown, in some aspects, a separate diode (e.g., a higher quality diode than the body diode that provides improved efficiency) may be coupled in parallel (e.g., one terminal of the diode coupled to the source terminal of the transistor, and one terminal of the diode coupled to the drain terminal of the transistor) with each of the first transistor 610 and second transistor 612 to operate as a passive rectifier instead of using the body diodes of the first transistor 610 and second transistor 612. Further, the first transistor 610 and second transistor 612 may be coupled in the circuit of the wireless power receiver 600 as shown (e.g., the drain and source terminals of the transistors coupled in the circuit). Further, each of the gate terminals of the first transistor 610 and second transistor 612 may be coupled to a controller configured to selectively open and close each of the first transistor 610 and second transistor 612 to act as an active rectifier.

The wireless power receiver 600 further includes a shunt capacitor 620, and a shunt tuning capacitor 622. The shunt tuning capacitor 622 may be selectively coupled to the wireless power receiver 600 by a transistor 624. The transistor 624 may be a normally (e.g., in a default or initial mode) on transistor (e.g., depletion mode FET) that is configured to couple the shunt tuning capacitor 622 to the wireless power receiver 600 at low induced voltages at the wireless power receiver 600 and there is insufficient power to control the active rectifier of the wireless power receiver 600. Further, the transistor 624 may be configured to decouple the shunt tuning capacitor 622 from the wireless power receiver 600 when the voltage at the wireless power receiver 600 is sufficient to control the active rectifier of the wireless power receiver 600. For example, the gate of the transistor 624 may be driven by or based on the induced voltage at the wireless power receiver 600. In some aspects, the gate of the transistor 624 may be coupled to a controller configured to selectively open and close the transistor 624 (e.g., the same controller as for the first transistor 610 and second transistor 612) based on the induced voltage and/or available power at the wireless power receiver 600.

The capacitance of the shunt tuning capacitor 622 may be selected (e.g., at design time), so that the capacitance of the shunt capacitor 620 and the shunt tuning capacitor 622 shunt tune the passive rectifier (e.g., to a resonant frequency of the resonator 605), when the transistor 624 is closed. Accordingly, the passive rectifier may function as discussed to have a high voltage gain when the induced voltage at the wireless power receiver 600 is low. Further, when the transistor 624 is open and the shunt tuning capacitor 622 is decoupled from the wireless power receiver 600, the passive rectifier may no longer be shunt tuned to the resonant frequency of the resonator 605 and therefore not have a high voltage gain for rectification when the voltage at the wireless power receiver is high.

It should be noted, that in some aspects, the transistor 624 may be a normally (e.g., in a default or initial mode) off transistor (enhanced mode FET) that is configured to decouple the shunt tuning capacitor 622 from the wireless power receiver 600 at low induced voltages at the wireless power receiver 600 and when there is insufficient power to control the active rectifier of the wireless power receiver 600. Further, the transistor 624 may be configured to couple the shunt tuning capacitor 622 from the wireless power receiver 600 when the voltage at the wireless power receiver 600 is sufficient to control the active rectifier of the wireless power receiver 600. In such aspects, the addition of the shunt tuning capacitor 622 may tune the passive rectifier away from the resonant frequency instead of to the resonant frequency, as the shunt capacitor 620 alone may tune the passive rectifier to the resonant frequency of the resonator 605.

The wireless power receiver 600 further includes a series capacitor 630, and a series tuning capacitor 632. The series tuning capacitor 632 may be selectively coupled to the wireless power receiver 600 by a transistor 634. The transistor 634 may be a normally (e.g., in a default or initial mode) off transistor (e.g., enhancement mode FET) that is configured to couple the series tuning capacitor 632 to the wireless power receiver 600 at high induced voltages at the wireless power receiver 600 and when there is sufficient power to control the active rectifier of the wireless power receiver 600. Further, the transistor 634 may be configured to decouple the series tuning capacitor 632 from the wireless power receiver 600 when the voltage at the wireless power receiver 600 is insufficient to control the active rectifier of the wireless power receiver 600. For example, the gate of the transistor 634 may be driven by or based on the induced voltage at the wireless power receiver 600. In some aspects, the gate of the transistor 634 may be coupled to a controller configured to selectively open and close the transistor 634 (e.g., the same controller as for the first transistor 610 and second transistor 612) based on the induced voltage and/or available power at the wireless power receiver 600.

The capacitance of the series tuning capacitor 632 may be selected (e.g., at design time), so that the overall capacitance of the series capacitor 630 and the series tuning capacitor 632 series tune the active rectifier (e.g., to a resonant frequency of the resonator 605), when the transistor 634 is closed. Accordingly, the active rectifier may function as discussed to have a steady voltage gain when the induced voltage at the wireless power receiver 600 is sufficient to power the active rectifier. Further, when the transistor 634 is open and the series tuning capacitor 632 is decoupled from the wireless power receiver 600, the active rectifier may not be series tuned to the resonant frequency of the resonator 605 and therefore not rectify an appropriate voltage. Therefore, based on the selective shunt tuning and series tuning of the wireless power receiver 600 due to the operation of transistors 624 and 634, the first transistor 610 and second transistor 612 may function as a shunt tuned passive rectifier, or a series tuned active rectifier, based on the power available at the wireless power receiver 600.

It should be noted, that in some aspects, the transistor 634 may be a normally (e.g., in a default or initial mode) on transistor (depletion mode FET) that is configured to decouple the series tuning capacitor 632 to the wireless power receiver 600 at high induced voltages at the wireless power receiver 600 and when there is sufficient power to control the active rectifier of the wireless power receiver 600. Further, the transistor 634 may be configured to couple the series tuning capacitor 632 from the wireless power receiver 600 when the voltage at the wireless power receiver 600 is insufficient to control the active rectifier of the wireless power receiver 600. In such circumstances, the addition of the series tuning capacitor 632 may tune the active rectifier away from the resonant frequency instead of to the resonant frequency, as the series capacitor 630 alone may tune the active rectifier to the resonant frequency of the resonator 605.

FIG. 6A is a circuit diagram illustrating another example of the wireless power receiver 600A including a hybrid rectifier, according to aspects of the disclosure. In particular, the wireless power receiver 600A may be the same as the wireless power receiver 600, except that the wireless power receiver 600A includes variable capacitor 620A to selectively shunt tune the passive rectifier of the wireless power receiver 600A, and a variable capacitor 630A to selectively series tune the active rectifier of the wireless power receiver 600A. The variable capacitor 620A may replace the shunt capacitor 620, the shunt tuning capacitor 622, and the transistor 624. The variable capacitor 630A may replace the series capacitor 630, the series tuning capacitor 632, and the transistor 634. The capacitance of the variable capacitors 620A and 630A may each be controlled by a controller, such as described with respect to transistors 624 and 634 based on the induced voltage and/or available power at the wireless power receiver 600A. There may be additional fixed capacitors in series with, or in parallel with, 620A and 630A, depending on the desired capacitance range or voltage rating of the shunt or series capacitance.

During operation of the wireless power receiver 600A, the capacitance of the variable capacitor 620A may be controlled to shunt tune the passive rectifier (e.g., to a resonant frequency of the resonator 605) when the induced voltage at the wireless power receiver 600 is low and there is insufficient power to control the active rectifier, to generate a high voltage gain from the passive rectifier. Further, when the power at the wireless power receiver 600A is sufficient to control the active rectifier, the capacitance of the variable capacitor 620 may be controlled to detune the passive rectifier so it does not have a high voltage gain for rectification.

Similarly, during operation of the wireless power receiver 600A, the capacitor 630A may be controlled to series tune the active rectifier (e.g., to a resonant frequency of the resonator 605) when the voltage at the wireless power receiver 600 is higher and there is sufficient power to control the active rectifier, to generate a steady voltage gain from the active rectifier. Further, when the power at the wireless power receiver 600A is insufficient to control the active rectifier, the capacitance of the variable capacitor 630 may be controlled to detune the active rectifier so it does not have a significant voltage gain for rectification.

The variable capacitors 620A and 630A may provide flexibility (e.g., a continuous range of adjustment) for shunt tuning the passive rectifier and series tuning the active rectifier, as compared to the wireless power receiver 600. Further, in some aspects, design of the wireless power receiver 600A may not need selection of specific sized capacitors and transistors for tuning the wireless power receiver 600A, as compared to the wireless power receiver 600. In some aspects, a fixed capacitance capacitor may be coupled in parallel with each of the variable capacitor 620A and variable capacitor 630A. Accordingly, the capacitances of each fixed capacitor may be summed with its respective variable capacitor 620A or 630A to determine the capacitance in the circuit. In some aspects, the practical range of variable capacitors may be limited, and accordingly including a fixed capacitor in parallel with the variable capacitor may help to accommodate a particular desired range of capacitances for the wireless power receiver 600A.

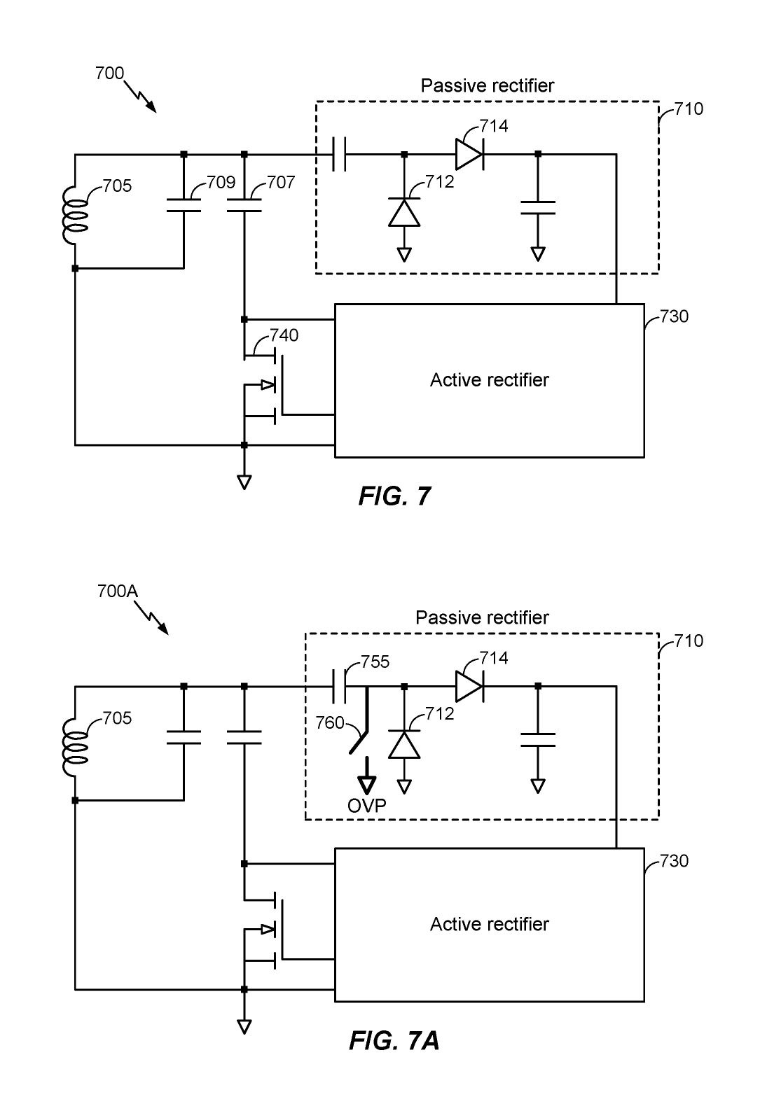

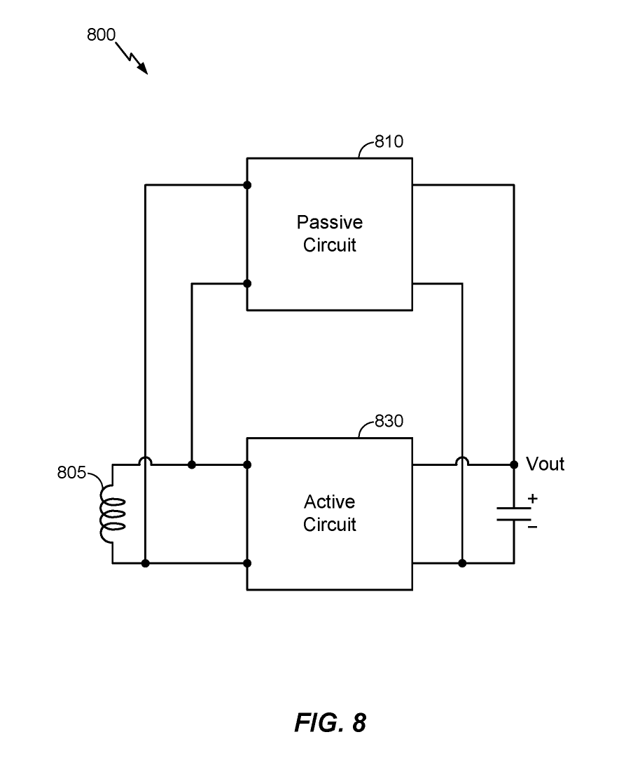

FIG. 7 is a circuit diagram illustrating another example of the wireless power receiver 700 including a hybrid rectifier, according to aspects of the disclosure. The wireless power receiver 700 includes a resonator 705 and a tuning capacitor 707. As shown, the wireless power 700 receiver includes separate circuitry for implementing a passive rectifier 710 and an active rectifier 730. The passive rectifier 710 includes diodes 712 and 714 for rectifying induced voltage at the wireless power receiver 700. The active rectifier 730 may include one or more active elements (e.g., switches) for rectifying induced voltage at the wireless power receiver 700.

The wireless power receiver 700 may further include a switch 740 (e.g., a transistor, such as a depletion mode FET) to selectively decouple the active rectifier 730 from the wireless power receiver 700. In particular, when the induced voltage at the wireless power receiver 700 is low and there is insufficient power to control the active rectifier 730, the switch 740 may be closed and therefore decouple the active rectifier 730 from the wireless power receiver 700, by shorting out the active rectifier 730. Further, closing the switch 740 causes the tuning capacitor 707 to act as a shunt tuning capacitor for shunt tuning the passive rectifier 710 (e.g., to a resonant frequency of the resonator 705). Accordingly, the passive rectifier may function as discussed to have a high voltage gain when the induced voltage at the wireless power receiver 700 is low. In some aspects, the wireless power receiver 700 also includes a shunt capacitor 709 that along with the tuning capacitor 707 shunt tunes the passive rectifier 710. Accordingly, even when the switch 740 is opened, the shunt capacitor 709 may still provide some shunt tuning of the passive rectifier 710.

When the voltage at the wireless power receiver 700 is higher and there is sufficient power to control the active rectifier 730, the switch 740 is opened. Accordingly, the active rectifier 730 is no longer shorted out from the circuit of the wireless power receiver 700 and can rectify voltage at the wireless power receiver 700. The tuning capacitor 707 is further coupled in series with the active rectifier 730 when the switch 740 is opened, thereby series tuning the active rectifier 730 (e.g., to a resonant frequency of the resonator 705). Opening the switch 740 further detunes the passive rectifier 710, so it does not have a high voltage gain for rectification. For example, the passive rectifier 710 may be tuned based on the shunt capacitor 709 instead of both the shunt capacitor 709 and tuning capacitor 707 and have a lower voltage gain for rectification. In certain aspects, each the gate terminal of the switch 740 may be coupled to a controller configured to selectively open and close the switch 740 based on the induced voltage and/or available power at the wireless power receiver 700.

FIG. 7A is a circuit diagram illustrating another example of the wireless power receiver 700A including a hybrid rectifier, according to aspects of the disclosure. In particular, the wireless power receiver 700A may be the same as the wireless power receiver 700, except that the wireless power receiver 700A includes an over voltage protection switch 760 (e.g., transistor, such as a FET). The over voltage protection switch 760 may be coupled between a reference potential (e.g., ground) and at a point between a series capacitor 755 and the diodes 712 and 714 of the passive rectifier 710. When closed, the switch 760 ensures that any voltage stress on the diodes 712 and 714 is eliminated by shorting the path to the diodes 712 and 714. In certain aspects, a capacitor 755 with a high impedance at the resonant frequency of the resonator 705 may be used to lower the power dissipated by the switch 760.

For example, the switch 760 may be closed when there is sufficient induced voltage and/or available power at the wireless power receiver 700 to operate the active rectifier 730. When there is not sufficient induced voltage and/or available power at the wireless power receiver 700 to operate the active rectifier 730, the switch 760 may be open to enable the passive rectifier 710. In certain aspects, a gate terminal of the switch 760 may be coupled to a controller configured to selectively open and close the switch 760 based on the induced voltage and/or available power at the wireless power receiver 700.

FIG. 8 is a circuit diagram illustrating another example of the wireless power receiver 800 including a hybrid rectifier, according to aspects of the disclosure. The wireless power receiver 800 includes a resonator 805. As shown, the wireless power receiver 800 includes a passive rectifier 810 and an active rectifier 830, each coupled to the resonator 805. Each of the passive rectifier 810 and active rectifier 830 may selectively operate to rectify an induced voltage at the resonator 805 based on one or more of the battery status (dead battery) of the wireless power receiver that includes the hybrid rectifier, a rectified voltage at the wireless power receiver, an induced voltage at the wireless power receiver, and a load power of the wireless power receiver. For example, the passive rectifier 810 and an active rectifier 830 may be coupled to a selectively operate the passive rectifier 810 and active rectifier 830 based on the induced voltage and/or available power at the wireless power receiver 800.

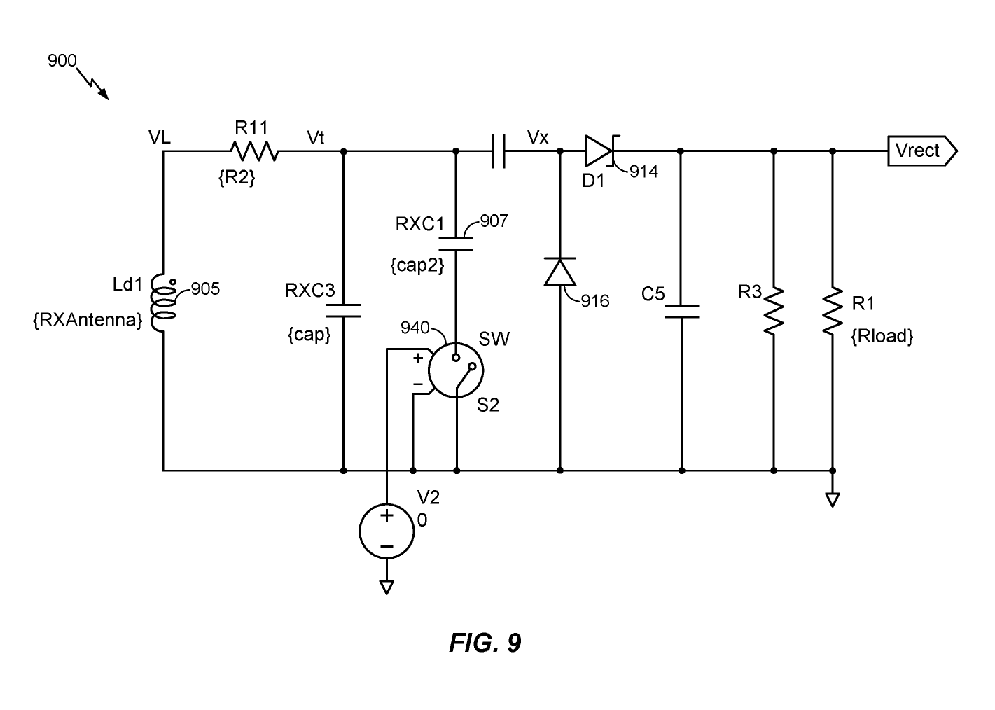

FIG. 9 is a circuit diagram illustrating another example of the wireless power receiver 900 including a hybrid rectifier, according to aspects of the disclosure. The wireless power receiver 900 may be similar to the wireless power receiver 700, but without an active rectifier. In particular, the wireless power receiver 900 may include only a passive rectifier (as shown, or another appropriate passive rectifier). For example, the wireless power receiver 900 includes a resonator 905 and diodes 914 and 916. The diode 914 may be configured to passively rectify voltages induced at the resonator 905. The wireless power receiver 900 may further include a shunt tuning capacitor 907 that may be used to shunt tune the passive rectifier of the wireless power receiver 900. In particular, the wireless power receiver 900 may include a switch 940 (e.g., a transistor) to selectively couple or decouple the shunt tuning capacitor 907 from the wireless power receiver 900. In certain aspects, a gate terminal of the switch 940 may be coupled to a controller configured to selectively open and close the switch 940 based on the induced voltage, rectified voltage, battery state, load and/or available power at the wireless power receiver 900.

In certain aspects, the controller may control the switch 940 using pulse width modulation (PWM) to tune and regulate the voltage gain/voltage output of the passive rectifier by switching in and out the shunt tuning capacitor 907. Accordingly, the voltage gain may be controlled to ensure that it remains and the appropriate level. For example, if a load change occurs (e.g., charging of a battery is started) the controller (e.g., based on information from a PMIC) may adjust the PWM of the switch 940 to tune the passive rectifier for the load change, even before the load change occurs. In some other aspects, the switch 940 may be in series with the resonator 905 instead of as shown, to break current flow with the resonator 905. In some other aspects, the switch 940 may be in parallel with the diode 914 instead of as shown, to short the diode 914. Similarly then, the switch 940 can be controlled to adjust the voltage gain of the passive rectifier.

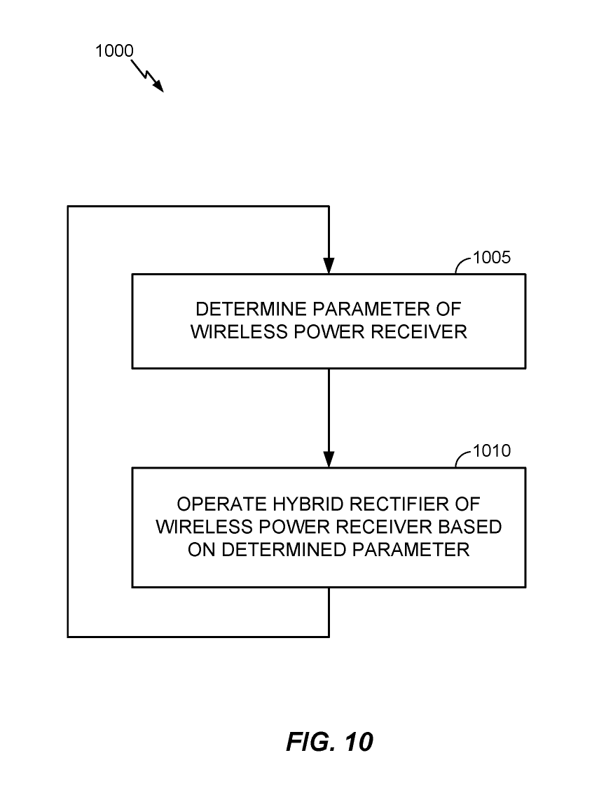

FIG. 10 is a flowchart of example operations 1000 for wireless power rectification, in accordance with certain aspects of the present disclosure.

At step 1005, at least one parameter, including one or more of a the battery status (dead battery) of the wireless power receiver that includes the hybrid rectifier, a rectified voltage at the wireless power receiver, an induced voltage at the wireless power receiver (e.g., induced at the resonator), and a load power of the wireless power receiver is determined. For example, the battery status of the wireless power receiver may be determined by a PMIC of the wireless power receiver.

At step 1010, the wireless power receiver is operated based on the determined at least one parameter. For example, if the battery status or other parameter(s) of the wireless power receiver do not satisfy a threshold (e.g., dead, charge too low, voltage too low, etc.), the wireless power receiver may operate a passive rectifier of the wireless power receiver to rectify induced power at the wireless power receiver, and not operate an active rectifier. Also for example, if the voltage or other parameter(s) of the wireless power receiver do not satisfy a threshold (e.g., dead, charge too low, voltage too low, etc.) the wireless power receiver may cause a shunt capacitance to be added to the receiver resonant circuit, thus increasing received voltage. The operations 1000 may then return to step 1005. When operations 1000 return to step 1010, if the parameter(s) now satisfy the threshold, the wireless power receiver may operate an active rectifier of the wireless power receiver to rectify induced power at the wireless power receiver, and/or may return to series tuning of the wireless power receiver. In some such circumstances, the passive rectifier may be operated as well, or not operated.

In another example, a passive rectifier may be operated (e.g., tuned) based on the at least one parameter.

The method of FIG. 10 may be used to operate/control any of wireless power receivers 600-900, or any other suitable wireless power receiver with a hybrid rectifier.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC with the processor, the bus interface, the user interface in the case of an access terminal), supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A wireless power receiver comprising:
a resonator configured to couple to a wireless field, the wireless field inducing a voltage in the resonator;
an active rectifier comprising one or more switches;
a passive rectifier comprising one or more diodes; and
a switch selectively coupling the active rectifier and the passive rectifier to the resonator.

2. The wireless power receiver of claim 1, further comprising a first capacitor coupled in series with the active rectifier.

3. The wireless power receiver of claim 2, further comprising a second capacitor coupled in parallel with the passive rectifier.

4. The wireless power receiver of claim 3, wherein the first capacitor and the second capacitor comprise the same capacitor.

5. The wireless power receiver of claim 3, wherein the first capacitor and the second capacitor each comprise a variable capacitor.

6. The wireless power receiver of claim 3, further comprising a controller configured to operate the switch to selectively couple the active rectifier and the passive rectifier to the resonator.

7. The wireless power receiver of claim 6, wherein the controller is further configured to selectively couple the first capacitor in series with the active rectifier to selectively series tune the resonator.

8. The wireless power receiver of claim 6, wherein the controller is further configured to selectively couple the second capacitor in parallel with the passive rectifier to selectively shunt tune the resonator.

9. The wireless power receiver of claim 2, further comprising a transistor coupled in parallel with the first capacitor, the transistor being configured to provide over voltage protection to the one or more diodes of the passive rectifier.

10. The wireless power receiver of claim 1, wherein the switch is configured to couple the passive rectifier to the resonator when the induced voltage in the resonator is below a threshold and configured to decouple the passive rectifier from the resonator when the induced voltage in the resonator is above the threshold.

11. The wireless power receiver of claim 1, wherein the one or more switches of the active rectifier are coupled in parallel with the one or more diodes of the passive rectifier.

12. The wireless power receiver of claim 1, wherein the one or more diodes correspond to body diodes of the one or more switches.

13. The wireless power receiver of claim 1, wherein the passive rectifier is configured to supply power to the active rectifier and not to a load, and wherein the active rectifier is configured to supply power to the load.

14. The wireless power receiver of claim 1, further comprising a battery, wherein the passive rectifier is configured to charge the battery, and wherein the switch is configured to couple the passive rectifier and decouple the active rectifier to the resonator when a charge of the battery is below a threshold and decouple the passive rectifier and couple the active rectifier to the resonator when the charge of the battery is above the threshold.

15. The wireless power receiver of claim 1, wherein the switch is configured to couple the passive rectifier and decouple the active rectifier to the resonator when a rectified voltage of the active rectifier is below a threshold and configured to decouple the passive rectifier and couple the active rectifier to the resonator when the rectified voltage of the active rectifier is above the threshold.

16. The wireless power receiver of claim 15, further comprising a controller configured to control the switch, wherein the controller is further configured to couple a first capacitor in parallel with the passive rectifier and decouple a second capacitor in series with the active rectifier when the rectified voltage of the active rectifier is below a threshold and configured to decouple the first capacitor in parallel with the passive rectifier and couple the second capacitor in series with the active rectifier when the rectified voltage of the active rectifier is above the threshold.

17. A method for operating a wireless power receiver, the method comprising:
determining an operating parameter of the wireless power receiver; and
selectively coupling an active rectifier and a passive rectifier to a resonator of the wireless power receiver based on the determined parameter.

18. The method of claim 17, wherein the parameter comprises a charge of a battery of the wireless power receiver, and further comprising coupling the passive rectifier and decoupling the active rectifier to the resonator when the charge of the battery is below a threshold and decoupling the passive rectifier and coupling the active rectifier to the resonator when the charge of the battery is above the threshold.

19. The method of claim 17, wherein the parameter comprises an induced voltage in the resonator, and further comprising coupling the passive rectifier and decoupling the active rectifier to the resonator when the induced voltage in the resonator is below a threshold and decoupling the passive rectifier and coupling the active rectifier to the resonator when the induced voltage in the resonator is above the threshold.

20. The method of claim 17, wherein the parameter comprises a rectified voltage at the wireless power receiver, and further comprising coupling the passive rectifier and decoupling the active rectifier to the resonator when the rectified voltage is below a threshold and decoupling the passive rectifier and coupling the active rectifier to the resonator when the rectified voltage is above the threshold.

21. The method of claim 17, further comprising coupling to a wireless field to induce a voltage at a resonator.

22. A wireless power receiver comprising:
a resonator configured to couple to a wireless field, the wireless field inducing a voltage in the resonator;
a passive rectifier comprising one or more diodes; and
a switch configured to selectively couple a shunt tuning capacitor or a series tuning capacitor to the passive rectifier.

23. The wireless power receiver of claim 22, wherein the switch is controlled using pulse width modulation.

24. The wireless power receiver of claim 23, further comprising a controller configured to adjust the pulse width modulation of the switch based on a load change of the wireless power receiver.

25. The wireless power receiver of claim 23, wherein the switch is controlled using pulse width modulation to selectively couple and decouple the shunt tuning capacitor to the passive rectifier.

26. The wireless power receiver of claim 22, wherein the switch is coupled between the shunt tuning capacitor or the series tuning capacitor and a reference potential.

27. The wireless power receiver of claim 22, wherein the switch is configured to selectively couple the shunt tuning capacitor or the series tuning capacitor to the passive rectifier based on at least one of an induced voltage in the resonator, a rectified voltage at the passive rectifier, and a charge of a battery.

28. The wireless power receiver of claim 22, further comprising a controller coupled to a gate terminal of the switch, the controller being configured to operate the switch.

29. A wireless power receiver comprising:
means for coupling the wireless power receiver to a wireless field, the wireless field inducing a voltage in the coupling means;
means for actively rectifying the induced voltage in the coupling means;
means for passively rectifying the induced voltage in the coupling means; and
means for selectively operating the actively rectifying means and the passively rectifying means based on the induced voltage in the coupling means.

30. The wireless power receiver of claim 29, further comprising:
means for selectively shunt tuning the coupling means when operating the passively rectifying means; and
means for selectively series tuning the coupling means when operating the actively rectifying means.
